(19) United States
(12) Patent Application Publication
(10) Pub. No.: US 2026/0086891 A1
(43) Pub. Date: Mar. 26, 2026

(54) MANAGING MESSAGING BETWEEN ARTIFICIAL INTELLIGENCE AGENTS

(71) Applicant: Maplebear Inc., San Francisco, CA (US)

(72) Inventors: Tilman Drerup, Palo Alto, CA (US); Sharath Rao Karikurve, Berkeley, CA (US); Haixun Wang, Bellevue, WA (US)

(21) Appl. No.: 18/892,152

(22) Filed: Sep. 20, 2024

(51) Int. Cl. G06F 9/54; G06N 3/0475; G06N 3/084

(52) U.S. Cl. CPC G06F 9/546; G06N 3/0475; G06N 3/084

(57) ABSTRACT

An online system is configured to manage messaging between artificial intelligence (AI) agents. A service request (such as a request to order items) is received at an online system from a user client device. A system AI agent and a user AI agent are instantiated with inputs that include a set of objectives or constraints that guides each of the system AI agent and the user AI agent during messaging with the other. The online system manages rounds of messaging between the system AI agent and the user AI agent, and at some point, a proposed agreement between the user and online system is extracted from the messaging. The proposed agreement may then be presented to the user or online system for approval.

### BACKGROUND

Conventional online systems receive requests from users for a variety of reasons. These include requests to order items, requests for information about a topic, requests to provide a service, among many others. Conventionally, a user sends the request to the online system and is then presented with a response. In the case of a user request to order one or more items, e.g., from a search query, the online system may respond with a product for purchase. The user then decides whether to buy the product or continue searching for an alternate product. Because the user has to individually search for a product and decide whether to purchase the product, this process can become rather time intensive for large lists of products. Moreover, conventionally, the user is typically left with a binary choice when presented with a product (i.e., to purchase it or not) and is not able to negotiate with the conventional online retailer to facilitate a sale of the product.

### SUMMARY

In accordance with one or more aspects of the disclosure, an online system manages messaging between artificial intelligence (AI) agents. The AI agents may include, e.g., one or more user AI agents (e.g., machine learning models) and one or more system AI agents (e.g., machine learning models). The online system may, e.g., create a user AI agent and a system AI agent. For example, a user AI agent may be instantiated with inputs that include a set of user objectives or a set of user constraints that guide the user AI agent during messaging with the system AI agent. And a system AI agent may be instantiated with inputs that include a set of system objectives or a set of system constraints that guides the system AI agent during messaging with the user AI agent.

A service request may be received from a user client device that is associated with the user AI agent. The service request may, e.g., include a proposed list of items of an online catalog to order, via the online system, from one or more sources.

The online system may prompt the user AI agent or the system AI agent to generate a message to the online system based on a received service request. For example, the prompt may instruct an AI agent (e.g., the user AI agent or the system AI agent) to generate a message that is based in part on the service request. The message may be, e.g., an initial offer that describes details (e.g., items, pricing, delivery time, delivery location, etc.) of a proposed order for items based on the received service request. The prompt is applied to the AI agent, which generates an output message. The online system may prompt the other AI agent based on the output message. In this manner, the online system manages one or more rounds of messaging between the user AI agent and the system AI agent.

At some point, a proposed agreement between the user and online system is extracted from the messaging. For example, the online system may extract the proposed agreement once a proposed order based on the service request is approved by both the system AI agent and the user AI agent. In some embodiments, the proposed agreement may then be presented to the user or online system for approval. Using AI agents improves scalability of conducting these conversations, or negotiations, as it allows the process to run very fast, even for a large number of items.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is an example sequence diagram describing management of messaging between AI agents, in accordance with some embodiments.

FIG. 4 is a flowchart for a method of managing messaging between AI agents, in accordance with some embodiments.

### DETAILED DESCRIPTION

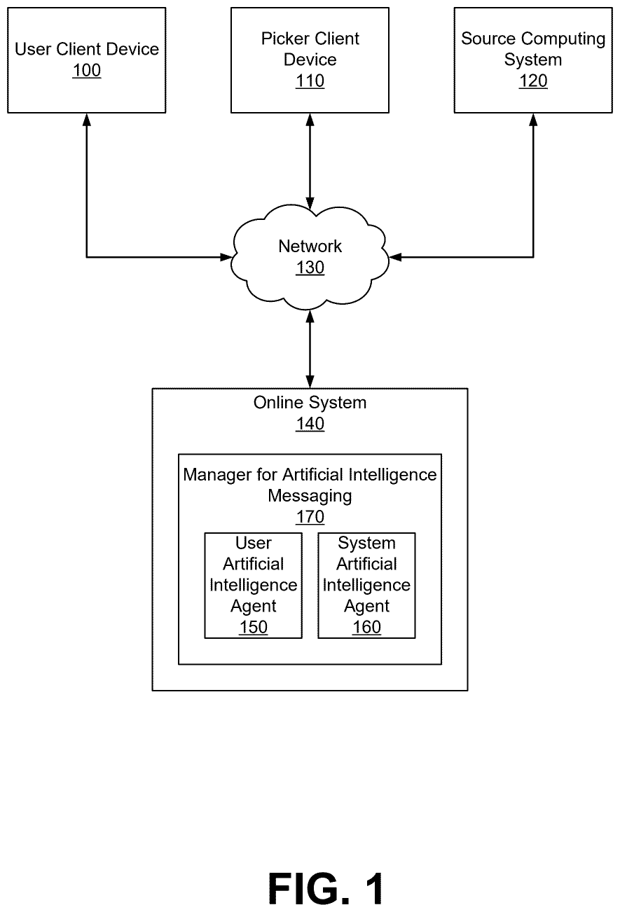

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 generates a service request for items specified in an ordering list that the user intends to order. The user client device 100 provides the service request to the online system 140. As described below the online system 140 may use artificial intelligence (AI) agents to coordinate the order. The ordering interface may include an AI agent option for selection (e.g., by the user). In some embodiments, responsive to the selection, the user client device 100 may send a service request to the online system 140 to coordinate the order using AI agents.

The user client device 100 may determine one or more of a set of user constraints or one or more of a set of user objectives. User constraints and user objectives control in part how a user AI agent (e.g., a user AI agent 150) negotiates on behalf of the user with a system AI agent (e.g., a system AI agent 160) representing the online system 140. User constraints are restrictions that the user AI agent representing interests of the user abides by while negotiating an order associated with a service request. And user objectives are goals that the user AI agent attempts to achieve while negotiating the order with the system AI agent 160. Constraints may include, e.g., maximum budget, time items are to be delivered by, allowing substitutions for items, dietary restrictions, brand preferences, packaging preferences etc. Objectives may include, e.g., source location, minimizing number of substitute items, having a delivery time within a threshold period of time of a requested delivery time, cost minimization, waste reduction in packaging, etc. Note in some embodiments, a user objective can also be a user constraint. For example, for a first order a user may not care about delivery time, and just set delivery time as a user objective. But in a later order, the user may need the items by a set time, and set the delivery time as a user constraint.

Values for user constraints or user objectives may be received from the user. In some embodiments, the user client device 100 may infer a value for a user constraint or a user objective based in part on, e.g., information about the user (e.g., user data). Note that each of the user constraints may be associated with a respective weight value, and each of the objectives may be associated with a respective weight value. In some embodiments, different user constraints may have different weight values or different user objects have different weight values. For example, a maximum budget may have a higher weighting than, e.g., allowing substitutions for items. In some embodiments, a service request may also include one or more user constraints or one or more user objectives. In other embodiments, the user client device 100 provides one or more user constraints or one or more user objectives to the online system 140 separate from the service request.

In some embodiments, user client device 100 receives a proposed agreement relating to the service request from the online system 140. The user client device 100 may present, e.g., via the ordering interface, the proposed agreement for approval or disapproval by the user. If the user rejects the proposed agreement, the user may provide a reason for the rejection. The user client device 100 may provide the reason for the rejection to the online system 140 which may have the AI agents negotiate a new proposed agreement based in part on the reason. Once a proposed agreement is approved by the user, the user client device 100 may coordinate with the online system 140 to complete the approved order.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 includes a manager for AI messaging 170. The manager for AI messaging 170 manages, for a given service request, messaging between a user AI agent 150 and a corresponding system AI agent 160 to come to an agreement regarding the service request. The user AI agent 150 negotiates on behalf of the user and the system AI agent 160 negotiates on behalf of the online system 140 (and in some cases the source computing system 120) to come to an agreement regarding the service request. Note that in FIG. 1, the user AI agent 150 is illustrated as being on the online system 140. In other embodiments, some or all of the user AI agent 150 may be part of the user client device 100.

The manager for AI messaging 170 may create one or more instances of a user AI agent (e.g., the user AI agent 150). For example, an instance of a user AI agent may be created responsive to receiving a service request. The manager for AI messaging 170 may create the instance of the user AI agent by, e.g., tuning a user AI agent (a machine-learning model) with one or more of a set of user objectives or a set of user constraints. The set of user objectives or the set of user constraints may be provided by the user client device 100.

The manager for AI messaging 170 may create one or more instances of a system AI agent (e.g., the system AI agent 160). For example, an instance of a system AI agent 160 may be created responsive to receiving the service request. In this manner, for a given service request, there may be a corresponding user AI agent 150 and system AI agent 160. The manager for AI messaging 170 may create the instance of the system AI agent 160 by tuning the system AI agent 160 (e.g., a machine-learning model) with one or more of a set of system objectives or a set of system constraints.

The manager for AI messaging 170 prompts at least one of the user AI agent 150 and the system AI agent 160 to generate a message (e.g., prepare a first offer) to the online system 140 based on the received service request. The manager for AI messaging 170 manages one or more rounds of messaging between the user AI agent 150 and the system AI agent 160. The manager for AI messaging 170 extracts, from the messaging between the user AI agent 150 and the system AI agent 160, a proposed agreement between the user associated with the service request and the online system 140.

The manager for AI messaging 170 outputs the proposed agreement to one or more of the user client devices 100 or the online system 140. The online system 140 may receive feedback on the proposed agreement. For example, the feedback may be approval of the order, and the online system 140 proceeds to complete the order. Alternatively, the feedback may be a rejection of the order, and the feedback may include one or more reasons for the rejection. The manager for AI messaging 170 may negotiate a new proposed agreement based in part on the feedback from the user, and provide the new proposed agreement to the user client device 100. Once a proposed agreement is approved, the user client device 100 may coordinate with the online system 140 to complete the approved order. In some embodiments, the user AI agent 150 may be authorized to complete the order without express approval by the user of the proposed agreement.

The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The manager for AI messaging 170 creates the user AI agent 150 and a corresponding system AI agent 160. The user may provide a list of item(s) to the user client device 100. For example, the service request may specify which groceries to be delivered from the grocery store and the quantity(ies) of each of the groceries. The user client device 100 generates a service request which is provided to the online system 140. The user AI agent 150 and the system AI agent 160 negotiate until the manager for AI messaging 170 is able to extract a proposed agreement that is approved by both the user AI agent 150 and the system AI agent 160. In some embodiments, the online system 140 provides the proposed agreement to the user client device 100 for approval by the user. The online system 140 receives feedback from the user client device 100, and based on the feedback may complete the order (e.g., the proposed agreement is approved) or instruct the manager for AI messaging 170 to have the user AI agent 150 and the system AI agent 160 generate a new proposed agreement (e.g., if the proposed agreement is rejected). In other embodiments, the user AI agent 150 may be authorized to complete the order without additional approval from the user.

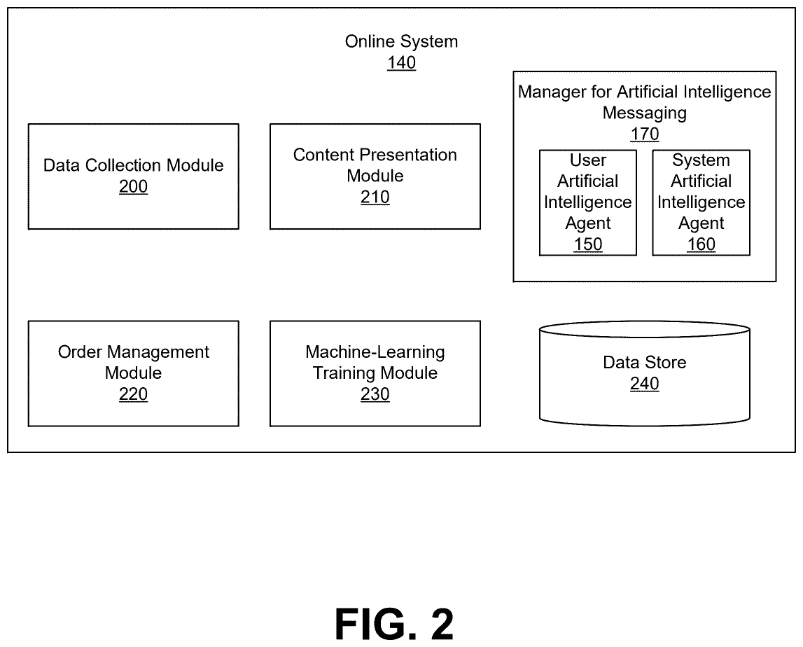

Once the order is approved, the online system 140 completes the order. For example, the online system 140 selects a picker to travel to the grocery store source location to collect the groceries in accordance with the approved order. The online system 140 may transmit an offer to a picker client device 110 associated with the picker. The offer may be for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, the manager for AI messaging 170, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 collects data describing a user only if the user has previously explicitly consented to the online system 140 collecting data describing the user, following appropriate disclosures about the collection and use of the users' data and any use of AI with the data. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, stored payment instruments, prior order histories (e.g., what items were ordered, from which source(s), price(s) paid, etc.). The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. Item data may also include pricing information. The pricing information may include a price for an item, discounts associated with items, etc. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be substitutes for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The data collection module 200 may collect messaging data. Messaging data describes aspects of negotiations between a system AI agent (e.g., the system AI agent 160) and a user AI agent (e.g., the user AI agent 150) via a messaging session managed by the manager for AI messaging 170. For example, messaging data may describe for a given negotiation: an service request, items proposed by the system agent, rejections by the user AI agent, reasons for the rejections by the user AI agent, output messages from user AI agent, output messages from system AI agent, incentives requested by the user AI agent, incentives proposed by the system AI agent, incentives accepted by the user AI agent, a number of times a user provided feedback during the negotiation, user constraints, user objectives, system constraints, system objectives, some other information describing the negotiation, or some combination thereof.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The manager for AI messaging 170 manages messaging between system AI agents and user AI agents. In some embodiments, the manager for AI messaging 170 manages a single system AI agent that may negotiate with user AI agents that are associated with different user client devices. In other embodiments, the manager for AI messaging 170 manages a plurality of system AI agents (e.g., one for each user AI agent).

The manager for AI messaging 170 may create one or more instances of a user AI agent (e.g., the user AI agent 150). For example, the manager for AI messaging 170 may create an instance of the user AI agent 150 responsive to receiving a service request from a user client device 100. The manager for AI messaging 170 may create the instance of the user AI agent 150 by, e.g., tuning the user AI agent 150 with one or more of a set of user objectives or one or more of a set of user constraints. The user AI agent 150 may also be tuned with additional information relevant to its task, such as a user's preferences and other profile information, historical activity (e.g., purchases or browsing activity), and the outcome of previous negotiations. Some or all of the set of user objectives or some or all of the set of user constraints may be provided by the user client device 100.

The manager for AI messaging 170 may create one or more instances of a system AI agent (e.g., the system AI agent 160). For example, the manager for AI messaging 170 may create an instance of the system AI agent 160 responsive to receiving the service request from the user client device 100. The manager for AI messaging 170 may create the instance of the system AI agent 160 by tuning the system AI agent 160 with one or more of a set of system objectives or one or more of a set of system constraints. System constraints and system objectives control in part how a system AI agent (e.g., the system AI agent 160) negotiates on behalf of the online system 140 with a user AI agent (e.g., the user AI agent 150) representing the online system 140. System constraints are restrictions that a system AI agent 160 abides by while coordinating with a corresponding user AI agent 150 to obtain a proposed agreement for an order based on a service request. And system objectives are goals that a system AI agent 160 attempts to achieve while negotiating the order. System constraints may include, e.g., available pickers, minimum profit per transaction, available inventory, available item discounts, etc. System objectives may include, e.g., having more than the minimum profit per transaction, ensuring a threshold level of ad impressions for items from the online catalog, ensuring a threshold level of ad impressions for sponsored items from the online catalog, maintaining a level of user satisfaction (e.g., selecting items that are requested by the user), assisting sources in turning over inventory, identifying potentially fraudulent users, etc. The system AI agents 160 may also be tuned with any other relevant information, such as historical outcomes of previous negotiations and other contextual information about the system's status (e.g., inventories)

The manager for AI messaging 170 prompts at least one of the user AI agent 150 and the system AI agent 160 to generate a message to the online system 140 based on the received service request. The prompt may be to prepare an initial offer that would satisfy the service request. The initial offer describes details of a proposed order for items based on the received service request.

The manager for AI messaging 170 manages one or more rounds of messaging between the user AI agent 150 and the system AI agent 160. For example, in some embodiments, the manager for AI messaging 170 may apply the prompt to the user AI agent 150, causing the user AI agent 150 to generate an output message. The output message describes a proposed order that is based in part on the service request, and satisfies one or more of the user objectives or one or more of the user constraints. The prompt may cause the user AI agent 150 to evaluate the service request to determine an initial set of one or more items that are part of the online catalog in a manner that satisfies one or more user objectives or one or more user constraints. In some embodiments, for at least one item or item category of the service request, the user AI agent 150 identifies a plurality of corresponding items in the online catalog. In some embodiments, the user AI agent 150 weights each of the plurality of identified items in accordance with one or more of the set of user objectives or one or more of the set of user constraints, ranks the weighted plurality of corresponding items, and selects an item having the highest ranking as a corresponding item to propose to the system AI agent 160 in an output message.

The manager for AI messaging 170 may prompt the system AI agent 160 based on the output message from the user AI agent 150. In some embodiments, the manager for AI messaging 170 may generate a prompt based in part on the output message from the user AI agent 150. The manager for AI messaging 170 may apply the prompt to the system AI agent 160.

The prompt may cause the system AI agent 160 to evaluate the service request and some or all of the output message to determine whether the proposed order would satisfy the service order request and one or more system objectives or one or more system constraints, and if not, generate a counteroffer. The output message generated by the system AI agent 160 may approve some or all of the proposed order or reject some or all of it. In cases where the system AI agent 160 rejects at least some of the proposed order, the system AI agent 160 may determine a counteroffer. The counteroffer may include, e.g., one or more incentives, one or more substitute items, etc. The system AI agent 160 may generate an output message including the counteroffer.

A counteroffer describes a proposed order that better satisfies the one or more system objectives or the one or more system constraints than the proposed order described in the output message from the user AI agent 150. Note, in embodiments where an item is requested in the service request and the counteroffer proposes some other item (referred to as a substitute item) as a substitute, the counteroffer may also include a reason for the proposed substitution (e.g., lower price, earlier delivery time, etc.). In some embodiments, the manager for AI messaging 170 may use retrieval-augmented generation to access a portion of the data store 240 maintained based on the output message from the user AI agent 150. The manager for AI messaging 170 may prompt the system AI agent 160 using information from the accessed portion of the data store 240. The manager for AI messaging 170 may prompt the user AI agent 150 based on the output message (e.g., includes a counteroffer) from the system AI agent 160.

The back and forth between the user AI agent 150 and the system AI agent 160 via the manager for AI messaging 170 continues until a proposed agreement that is based in part on the service request is achieved. The manager for AI messaging 170 extracts, from the messaging between the user AI agent 150 and the system AI agent 160, the proposed agreement between the user associated with the service request and the online system 140. For example, the manager for AI messaging 170 may extract a proposed agreement once a proposed order based on the service request is approved by both the system AI agent 160 and the user AI agent 150. The proposed order may cover, e.g., items for purchase, pricing for items, delivery time, delivery location, source for the items, incentives (that would be applied to the order or a future order), assigned picker(s), some other aspect of an order, or some combination thereof.

The manager for AI messaging 170 outputs the proposed agreement to one or more of the user client devices 100 or the online system 140. The online system 140 may receive feedback on the proposed agreement from the user client device 100. For example, the feedback may be approval of the order by the user. Alternatively, the feedback may be a rejection of the order, and the feedback may include one or more reasons for the rejection. The manager for AI messaging 170 may negotiate a new proposed agreement based in part on the feedback from the user, and provide the new proposed agreement to the user client device 100. The back and forth between the user AI agent and the system AI agent occurs until the user AI agent approves the order (or it is canceled by the user AI agent or the system AI agent 160). Once a proposed agreement is approved, the user client device 100 may coordinate with the online system 140 to complete the approved order. In some embodiments, the user AI agent 150 may be authorized to complete the order without express approval by the user of the proposed agreement.

The order management module 220 manages orders for items from users. The order management module 220 receives orders from a user client device 100 (e.g., as negotiated and agreed upon between the system AI agent 160 and the user AI agent 150) and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order or as agreed between the user AI agent 150 and the system AI agent 160. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine-learning training module 230 may be used to train one or more system AI agents (e.g., the system AI agent 160), and one or more user AI agents (e.g., the user AI agent 150). The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data (e.g., prior order histories, user preferences, etc.), picker data, item data, order data, or messaging data, which may be referred to respectively as, training user data, training picker data, training item data, training order data, and training messaging data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments the machine-learning training module 230 may tune a system AI agent. The machine-learning training module 230 may access a set of training examples, each training example comprising training user data, training messaging data, and training item data. The machine-learning training module 230 may apply the system AI agent to the set of training examples to generate a training output. The machine-learning training module 230 may generate an error term using a loss function, the error term based in part on evaluating the training output against the set of system objectives or the set of system constraints. The machine-learning training module 230 may back-propagate the error term to update a set of parameters of the large language model associated with the system AI agent.

In some embodiments, the machine-learning training module 230 may retrain a machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 retrains the machine-learning model using the additional training data, using any of the methods described above. This deployment and retraining process may be repeated over the lifetime use for the machine-learning model. This way, the machine-learning model continues to improve its output and adapts to changes in the system environment, thereby improving the functionality of the online system 140 as a whole in its performance of the tasks described herein. In this manner, one or more system AI agents (and in some embodiments one or more user AI agents) may be retrained.

For example, the machine-learning training module 230 may generate additional training examples based on a plurality of previous service requests from users, each training example including a plurality of rounds of messaging associated with the previous service request. The machine-learning training module 230 may label each training example based on a comparison of the proposed agreement extracted from the messaging to a metric associated with the online system. The machine-learning training module 230 may retrain the system AI agent using the additional training examples.

The data store 240 stores data used by the online system 140. For example, the data store 240 stores user data, item data, order data, messaging data, and picker data for use by the online system 140. In some embodiments, the data store 240 may also store constraints associated with users. The data store 240 also stores trained machine-learning models (e.g., one or more system AI agents, one or more user AI agents) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

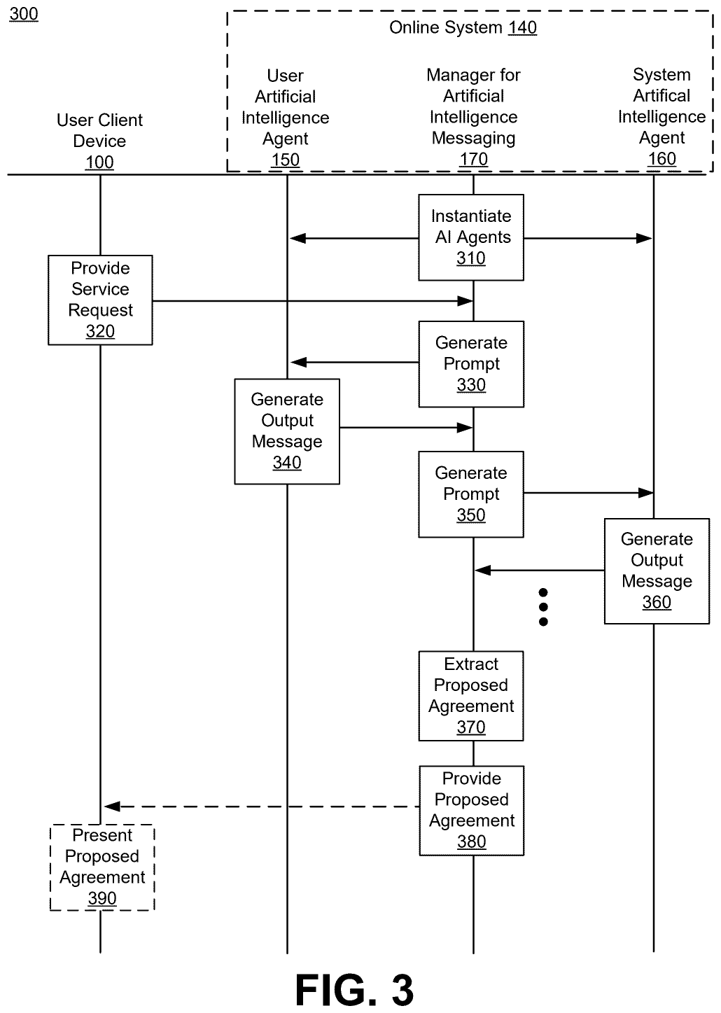

FIG. 3 is an example sequence diagram 300 describing management of messaging between AI agents, in accordance with some embodiments. Alternative embodiments may include more, fewer, or different interactions from those illustrated in FIG. 3, and the steps may be performed in a different order from that illustrated in FIG. 3.

In some embodiments, the manager for the AI messaging 170 of the online system 140 instantiates 310 a user AI agent 150 and a system AI agent 160. For example, the manager for the AI messaging 170 may create an instance of the user AI agent 150 by, e.g., tuning the user AI agent 150 (e.g., a machine-learning model) with one or more of a set of user objectives or one or more of a set of user constraints. The manager for the AI messaging 170 may instantiate the user AI agent 150 using information (e.g., prior order histories, user preferences, etc.) about the user. For example, the manager for AI messaging 170 may retrieve, from the data store 240, information associated with the user (e.g., previous orders by the user, user preferences, some other user data, or some combination thereof). The manager for AI messaging 170 may generate the set of user objectives (e.g., source location, minimizing number of substitute items, etc.) or the set of user constraints (e.g., maximum budget, allowing substitutions for items, etc) based at least in part on the retrieved information. In some embodiments, some or all of the set of user objectives or some or all of the set of user constraints may be provided by the user client device 100. As shown in the figures, the user AI agent 150 is located on the online system 140. In other embodiments (not shown), the user AI agent 150 is located on the user client device 100 and some or all the functionality of the user AI agent 150 is performed by the user client device 100.

The manager for the AI messaging 170 may create an instance of a system AI agent 160. In some embodiments, the manager for the AI messaging 170 retrieves a set of system objectives (e.g., having more than the minimum profit per transaction, ensuring a threshold level of ad impressions for items from the online catalog, etc.) or a set of system constraints (e.g., available pickers, minimum profit per transaction) from the data store 240. The manager for the AI messaging 170 may create an instance of the system AI agent 160 by, e.g., tuning the system AI agent 160 (e.g., a machine-learning model) with one or more of the set of system objectives or one or more of the set of system constraints. Note in some embodiments, some of the set of system objectives or some of the set of system constraints may be based in part on user data. In some embodiments, the manager for the AI messaging 170 may prompt (e.g., during at least one round of the plurality of rounds of messaging between the user AI agent 150 and the system AI agent 160) the system AI agent 160 with a description of the set of system objectives or the set of system constraints.

The user client device 100 generates a service request. A user associated with the user client device 100 selects a list of one or more items (e.g., Island Farms Organic Non-Fat Milk, 1 quart) or one or more item descriptions (e.g., orange juice) using, e.g., an ordering interface of the user client device 100. The user client device 100 uses the list to generate the service request. The user client device 100 provides 320 the service request to the online system 140. In some embodiments, an ordering interface of the user client device 100 may include an AI agent option for the user to select, and responsive to the selection, the service request may include instructions for the online system 140 to address the service request using AI agents. Note in alternate embodiments, the online system 140 performs step 310 responsive to receipt of a service request.

The manager for the AI messaging 170 generates 330 a prompt based in part on the service request. The prompt instructs an AI agent (e.g., the user AI agent 150) to generate an output message that is based in part on the service request. The output message may be, e.g., an initial offer that describes details (e.g., items, pricing, delivery time, delivery location, etc.) of a proposed order for items based on the received service request.

In one or more embodiments, the prompt is applied (e.g., by the manager for the AI messaging 170) to the user AI agent 150, causing the user AI agent 150 to generate 340 the output message. The user AI agent 150 evaluates the service request to determine one or more items that are part of the online catalog and that satisfy one or more the set of user objectives or one or more of the set of user constraints. In some embodiments, the output message may also include a request for a discount on one or more items. The output message is provided to the manager for the AI messaging 170.

The manager for the AI messaging 170 generates 350 a prompt based in part on the output message from the user AI agent 150. For example, the prompt may instruct the system AI agent 160 to evaluate the service request and some or all of the output message to determine whether the proposed order would satisfy the service request and one or more system objectives or one or more system constraints, and if not, generate a counteroffer. In some embodiments, prompt may instruct the system AI agent 160 to consider a discount requested by the user AI agent 150 based on some or all of the set of system objectives or some or all of the set of system constraints.

The prompt is applied (e.g., by the manager for the AI messaging 170) to the system AI agent 160, causing the system AI agent 160 to generate 360 an output message. The prompt may cause the system AI agent 160 to evaluate the service request and some or all of the output message to determine whether the proposed order would satisfy the service order request and one or more system objectives or one or more system constraints, and if not, generate a counteroffer. The output message generated by the system AI agent 160 may approve some or all of the proposed order or reject some or all of the proposed order. In cases where the system AI agent 160 rejects at least some of the proposed order, the system AI agent 160 may determine a counteroffer. The counteroffer may include, e.g., one or more incentives, one or more substitute items, etc. In embodiments where an item is requested in a proposed order and the system AI agent 160 in the counteroffer proposes some other item (i.e., as substitute item) as a substitute, the system AI agent 160 may also include a reason for the proposed substitution (e.g., lower price, earlier delivery time, etc.). Likewise, in some embodiments, if the system AI agent 160 rejects an item of a proposed order, the system AI agent 160 may provide a reason for the rejection in the output message. And the manager for the AI messaging 170 may prompt the user AI agent 150 to respond to the reason for the rejection based on the set of user objectives or the set of user constraints. In some embodiments, rejections may be addressed item by item. Or in other embodiments, a rejection of the order may be evaluated in view of the proposed order as a whole.

The back and forth between the user AI agent 150 and the system AI agent 160 via the manager for AI messaging 170 may continue until a proposed agreement that is based in part on the service request is achieved. The manager for AI messaging 170 extracts 370, from the messaging between the user AI agent 150 and the system AI agent 160, a proposed agreement between the user associated with the service request and the online system 140. The manager for AI messaging 170 may extract a proposed agreement once a proposed order based on the service request is approved by both the system AI agent 160 and the user AI agent 150. The proposed agreement may cover, e.g., items for purchase, pricing for items, delivery time, delivery location, source for the items, incentives (that would be applied to the order or a future order), assigned picker(s), some other aspect of an order, or some combination thereof.

In some embodiments, the manager for AI messaging 170 provides 380 the proposed agreement to at least one of the user client device 100 and the online system 140. For example, in some embodiments the manager for AI messaging 170 provides the proposed agreement to the user client device 100. The user client device 100 may present 390 some or all of the proposed agreement to the user for approval or rejection. The user may provide feedback that rejects or approves some or all of the proposed agreement. The user client device 100 provides the feedback to the online system 140. In embodiments, where the feedback rejects some or all of the proposed agreement, the manager for AI messaging 170 begins a new one or more rounds of messaging between the user AI agent 150 and the system AI agent 160 to negotiate a new proposed agreement based in part on the feedback. In embodiments, where the user has approved the proposed agreement, the online system 140 proceeds to fulfill the order described by the proposed agreement. Note in alternate embodiments (e.g., if authorized by the user), once both the user AI agent and the system AI agent 160 approve a proposed agreement, the online system 140 may proceed to fulfill the order described by the proposed agreement without sending it to the user client device 100 for express approval by the user.

As shown in the figures, the manager for AI messaging 170 first generates 300 the prompt for the user AI agent 150. In other embodiments, the manager for AI messaging 170 first generates 300 the prompt for the system AI agent 160. Regardless of which AI agent is prompted first, the manager for AI messaging 170 manages the resulting one or more rounds of messaging between the user AI agent 150 and the system AI agent 160 to obtain a proposed agreement.

The negotiation between the user AI agent 150 and the system AI agent 160 can quickly identify items that not only meet one or more user constraints or one or more user objectives but also meet one or more system objectives or one or more system constraints. In this manner, the online system 140 is able to fulfill orders that not only satisfy the user, but also, e.g., satisfy sources (e.g., helping turn over inventory), generate advertising revenue (e.g., presenting ad for substitute item), reduce fulfillment costs by surfacing easier to find items, reduce time and effort needed to create orders, provide personalized offers to users, reduce cognitive or physical effort required to interact with the platform, etc.

In one or more embodiments, the manager for AI messaging 170 uses a defined messaging format (e.g., using JSON) to manage the messaging between the AI agents effectively. Using a define messaging format allows the manager for AI messaging 170 to structure the messages exchanged between user AI agents and system AI agents, which may be useful to achieve clarity and consistency in the messaging. One example JSON format that can be used to facilitate communication between AI agents is defined as follows:

```
{
  “message_id”: “string”,
  “timestamp”: “ISO 8601 format”,
  “sender”: {
    “type”: “UserAI | SystemAI”,
    “agent_id”: “string”
  },
  “receiver”: {
    “type”: “UserAI | SystemAI | OnlineSystem”,
    “agent_id”: “string”
  },
  “service_request”: {
    “request_id”: “string”,
    “items”: [
      {
        “item_id”: “string”,
        “quantity”: “integer”,
        “description”: “string”,
        “price”: “float”
      }
    ],
    “constraints”: {
      “budget”: “float”,
      “delivery_time”: “string”,
      “allow_substitutions”: “boolean”
    },
    “objectives”: {
      “source_location”: “string”,
      “minimize_substitutions”: “boolean”
    }
  },
  “message_content”: {
    “proposal”: {
      “items”: [
        {
          “item_id”: “string”,
          “substitute_id”: “string | null”,
          “reason”: “string | null”
        }
      ],
      “total_price”: “float”,
      “delivery_time”: “string”,
      “incentives”: [
        {
          “type”: “discount | coupon | other”,
          “value”: “float | string”
        }
      ]
    },
    “counter_offer”: {
      “note”: “string”
    },
    “approval_status”: {
      “approved”: “boolean”,
      “reason_for_rejection”: “string | null”
    }
  }
}
```

In this example, the following variables are used:
message_id and timestamp: Unique identifiers and time tracking for each message
sender and receiver: Defines who is sending the message and who the intended recipient is, distinguishing between user AI, system AI, and the central online system.
service_request: Includes pertinent details of the user's request such as items, constraints, and objectives.
message_content:
   proposal: Contains the proposed terms of the agreement, including item adjustments and any applicable incentives.
   counter_offer: Allows for further negotiation with reasoning behind counter-offers.
   approval_status: Captures the outcome of negotiations in terms of approval or rejection and justifications when applicable.
      Although the above format is just one example that can be used with embodiments, this JSON format allows the AI agents to clearly specify the exchanged information, including service requests, proposals, counter-offers, and decisions. Each field provides a structured and comprehensive communication framework, promoting efficiency and reducing ambiguity in interactions between AI agents.

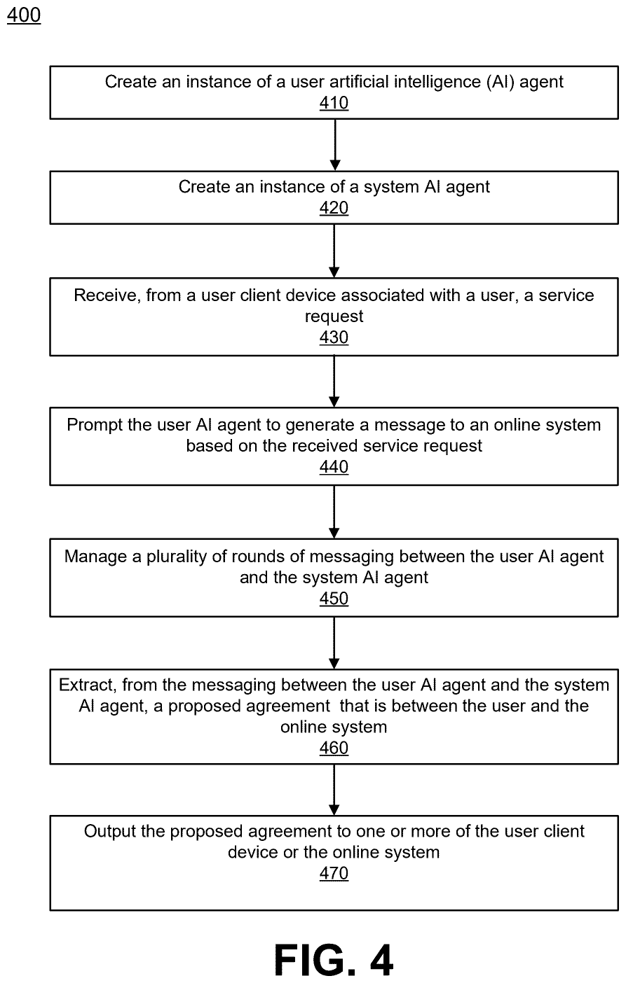

FIG. 4 is a flowchart for a method of managing messaging between AI agents, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system creates 410 an instance of a user AI agent (e.g., the user AI agent 150). For example, the online system may use a manager for AI messaging (e.g., the manager for AI messaging 170) to tune the user AI agent (a machine-learning model) with one or more of a set of user objectives or one or more of a set of user constraints. The manager for the AI messaging may instantiate the user AI agent using information (e.g., prior order histories, user preferences, etc.) about the user. For example, the manager for AI messaging may retrieve, from a data store (e.g., the data store 240), information associated with the user (e.g., previous orders by the user) and generate some or all of the set of user objectives or some or all of the set of user constraints based at least in part on the retrieved information. In some embodiments, some or all of the set of user objectives or some or all of the set of user constraints may be received from the user client device 100.

The online system creates 420 an instance of a system AI agent (e.g., the system AI agent 160). In some embodiments, the manager for the AI messaging retrieves a set of system objectives or a set of system constraints from the data store. The manager for the AI messaging may create an instance of the system AI agent by, e.g., tuning the system AI agent (a machine-learning model) with one or more of the set of system objectives or one or more of the set of system constraints. Note in some embodiments, some of the set of system objectives or some of the set of system constraints may be based in part on user data.

The online system 140 receives 430 a service request from a user client device (e.g., the user client device 100) associated with a user. The online system 140 may, e.g., receive a request by the user (via the user client device) to order a set of items from the online system.

Note in the illustrated embodiments, step 430 occurs after steps 410 and 420. In other embodiments, one or both of steps 410 and 420 occur after step 430. For example, the manager for the AI messaging may create the system AI agent and the user AI agent responsive to the online system receiving the service request.

The online system 140 prompts 440 the user AI agent to generate a message to the online system (e.g., the manager for the AI messaging) based on the received service request. The manager for the AI messaging may generate a prompt based in part on the service request. The prompt may instruct the user AI agent to generate a message that is based in part on the service request. The message may be, e.g., an initial offer that describes details (e.g., items, pricing, delivery time, delivery location, etc.) of a proposed order for items based on the received service request. The prompt is applied (e.g., by the manager for the AI messaging) to the user AI agent, causing the user AI agent to generate the output message.

The online system 140 manages 450 one or more rounds of messaging between the user AI agent and the system AI agent. For example, the manager for the AI messaging may generate a prompt based in part on the output message from the user AI agent. For example, the prompt may instruct the system AI agent to evaluate the service request and some or all of the output message to determine whether the proposed order would satisfy the service request and one or more system objectives or one or more system constraints, and if not, generate a counteroffer. The prompt is applied (e.g., by the manager for the AI messaging) to the system AI agent, causing the system AI agent to generate an output message. The output message generated by the system AI agent may approve some or all of the proposed order or reject some or all of the proposed order. In cases where the system AI agent rejects some or all of the proposed order, the output message may include the proposed order, but adjusted subject to a counteroffer (e.g., include a substitute item in lieu of an item specified in the service request, incentive to complete the purchase, adjusted delivery time, etc.). The back and forth between the user AI agent and the system AI agent via the manager for AI messaging continues until a proposed agreement regarding the service request is achieved.

The online system extracts 460, from the messaging between the user AI agent and the system AI agent, a proposed agreement between the user and the online system 140. The proposed agreement is responsive to the service request. The manager for AI messaging may extract the proposed agreement once a proposed order based on the service request is approved by both the system AI agent 160 and the user AI agent 150. For example, the online system may identify, based on the messaging between the user AI agent and the system AI agent, a source for the set of items. The online system may identify, based on the messaging between the user AI agent and the system AI agent, a set of one or more items (e.g., products) from an online catalog associated with the source for fulfilling the request to order the set of items from the online system. The set of one or more items generally corresponds to the set of items, however, the one or more rounds of messaging may have introduced differences. For example, the set of one or more items may include a substitute item for an item that was originally specified in the set of items.

The online system outputs 470 the proposed agreement to one or more of the user client device or the online system. For example, in some embodiments, once the proposed agreement has been extracted, the online system may proceed with fulfilling the order as detailed in the proposed agreement. In other embodiments, the online system may provide the proposed agreement to the user client device for feedback (e.g., approval, rejection, etc.). The online system may receive the feedback, and respond accordingly. For example, in embodiments, where the feedback rejects some or all of the proposed order, the manager for AI messaging may begin a new one or more rounds of messaging between the user AI agent and the system AI agent to negotiate a new proposed agreement based in part on the feedback. And in embodiments, where the user has approved the proposed agreement, the online system may proceed to fulfill the order as described by the proposed order.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium of an online system, comprising:
creating an instance of a user artificial intelligence (AI) agent, the user AI agent comprising a large language model, wherein creating the instance of the user AI agent comprises tuning the user AI agent with one or more of a set of user objectives or a set of user constraints;
creating an instance of a system AI agent, the system AI agent comprising a large language model, wherein creating the instance of the system AI agent comprises tuning the system AI agent with one or more of a set of system objectives or a set of system constraints;
receiving, from a user client device associated with a user, a service request;
prompting the user AI agent to generate a message to an online system based on the received service request;
managing a plurality of rounds of messaging between the user AI agent and the system AI agent, wherein managing at least one round of the plurality of rounds of messaging between the user AI agent and the system AI agent comprises:
receiving, from the user AI agent, an output message,
prompting the system AI agent based on the output message from the user AI agent,
receiving, from the system AI agent, an output message, and
prompting the user AI agent based on the output message from the system AI agent;
extracting, from the messaging between the user AI agent and the system AI agent, a proposed agreement between the user and the online system responsive to the service request; and
outputting the proposed agreement to one or more of the user client device or the online system.

2. The method of claim 1, wherein tuning the system AI agent comprises:
accessing a set of training examples, each training example comprising including training user data, training messaging data, and training item data;
applying the system AI agent to the set of training examples to generate a training output;
generating an error term using a loss function, the error term based in part on evaluating the training output against the set of system objectives or the set of system constraints; and
back-propagating the error term to update a set of parameters of the large language model associated with the system AI agent.

3. The method of claim 1, wherein tuning the system AI agent comprises:
prompting the system AI agent, during at least one round of the plurality of rounds of messaging between the user AI agent and the system AI agent, with a description of the set of system objectives or the set of system constraints.

4. The method of claim 1, wherein tuning the user AI agent with one or more of the set of user objectives or the set of user constraints comprises:
retrieving, from a user database maintained by the online system, information about previous orders by the user; and
generating the set of user objectives or the set of user constraints based at least in part on the retrieved information about previous orders by the user.

5. The method of claim 1, further comprising:
generating additional training examples based on a plurality of previous service requests from users, each training example including the plurality of rounds of messaging associated with the previous service request;
labeling each training example based on a comparison of the proposed agreement extracted from the messaging to a metric associated with the online system; and
retraining the system AI agent using the additional training examples.

6. The method of claim 1, wherein prompting the system AI agent based on the output message from the user AI agent comprises:
using retrieval-augmented generation to access a portion of a database maintained by the online system based on the output message from the user AI agent; and
prompting the system AI agent using information from the accessed portion of the database.

7. The method of claim 1, wherein receiving the service request comprises receiving a request by the user to order a set of items from the online system.

8. The method of claim 7, extracting, from the messaging between the user AI agent and the system AI agent, the proposed agreement between the user and the online system responsive to the service request comprises:
identifying, based on the messaging between the user AI agent and the system AI agent, a source for the set of items; and
identifying, based on the messaging between the user AI agent and the system AI agent, a set of products from a catalog associated with the source for fulfilling the request to order the set of items from the online system.

9. The method of claim 7, wherein managing at least one round of the plurality of rounds of messaging between the user AI agent and the system AI agent comprises:
receiving, from the system AI agent, a rejection of an item of a proposed list of one or more items, the rejection including a reason for the rejection; and
prompting the user AI agent to respond to the reason for the rejection based on the set of user objectives or the set of user constraints.

10. The method of claim 7, wherein managing at least one round of the plurality of rounds of messaging between the user AI agent and the system AI agent comprises:
receiving, from the user AI agent, a request for a discount on the set of items; and
prompting the system AI agent to consider the requested discount based on the set of system objectives or the set of system constraints.

11. A computer program product comprising a non-transitory computer readable storage medium having instructions encoded thereon that, when executed by a processor of a computer system, cause the computer system to perform steps comprising:
creating an instance of a user artificial intelligence (AI) agent, the user AI agent comprising a large language model, wherein creating the instance of the user AI agent comprises tuning the user AI agent with one or more of a set of user objectives or a set of user constraints;
creating an instance of a system AI agent, the system AI agent comprising a large language model, wherein creating the instance of the system AI agent comprises tuning the system AI agent with one or more of a set of system objectives or a set of system constraints;
receiving, from a user client device associated with a user, a service request;
prompting the user AI agent to generate a message to an online system based on the received service request;
managing a plurality of rounds of messaging between the user AI agent and the system AI agent, wherein managing at least one round of the plurality of rounds of messaging between the user AI agent and the system AI agent comprises:
receiving, from the user AI agent, an output message,
prompting the system AI agent based on the output message from the user AI agent,
receiving, from the system AI agent, an output message, and
prompting the user AI agent based on the output message from the system AI agent;
extracting, from the messaging between the user AI agent and the system AI agent, a proposed agreement between the user and the online system responsive to the service request; and
outputting the proposed agreement to one or more of the user client device or the online system.

12. The computer program product of claim 11, wherein the encoded instructions for tuning the system AI agent cause the computer system to perform steps comprising:
accessing a set of training examples, each training example comprising including training user data, training messaging data, and training item data;
applying the system AI agent to the set of training examples to generate a training output;
generating an error term using a loss function, the error term based in part on evaluating the training output against the set of system objectives or the set of system constraints; and
back-propagating the error term to update a set of parameters of the large language model associated with the system AI agent.

13. The computer program product of claim 11, wherein the encoded instructions for tuning the system AI agent cause the computer system to perform steps comprising:
prompting the system AI agent, during at least one round of the plurality of rounds of messaging between the user AI agent and the system AI agent, with a description of the set of system objectives or the set of system constraints.

14. The computer program product of claim 11, wherein the encoded instructions for tuning the user AI agent with one or more of the set of user objectives or the set of user constraints cause the computer system to perform steps comprising:
retrieving, from a user database maintained by the online system, information about previous orders by the user; and
generating the set of user objectives or the set of user constraints based at least in part on the retrieved information about previous orders by the user.

15. The computer program product of claim 11, further comprising encoded instructions that when executed cause the computer system to perform steps comprising:
generating additional training examples based on a plurality of previous service requests from users, each training example including the plurality of rounds of messaging associated with the previous service request;
labeling each training example based on a comparison of the proposed agreement extracted from the messaging to a metric associated with the online system; and
retraining the system AI agent using the additional training examples.

16. The computer program product of claim 11, wherein the encoded instructions for prompting the system AI agent based on the output message from the user AI agent cause the computer system to perform steps comprising:
using retrieval-augmented generation to access a portion of a database maintained by the online system based on the output message from the user AI agent; and
prompting the system AI agent using information from the accessed portion of the database.

17. The computer program product of claim 11, wherein the encoded instructions for receiving the service request cause the computer system to perform steps comprising:
receiving a request by the user to order a set of items from the online system.

18. The computer program product of claim 17, wherein the encoded instructions for extracting, from the messaging between the user AI agent and the system AI agent, the proposed agreement between the user and the online system responsive to the service request cause the computer system to perform steps comprising:
identifying, based on the messaging between the user AI agent and the system AI agent, a source for the set of items; and
identifying, based on the messaging between the user AI agent and the system AI agent, a set of products from a catalog associated with the source for fulfilling the request to order the set of items from the online system.

19. The computer program product of claim 17, wherein the encoded instructions for managing at least one round of the plurality of rounds of messaging between the user AI agent and the system AI agent cause the computer system to perform steps comprising:
receiving, from the system AI agent, a rejection of an item of a proposed list of one or more items, the rejection including a reason for the rejection; and
prompting the user AI agent to respond to the reason for the rejection based on the set of user objectives or the set of user constraints.

20. A computer system comprising:
a processor; and
a non-transitory computer readable storage medium having instructions encoded thereon that, when executed by the processor, cause the computer system to perform steps comprising:
creating an instance of a user artificial intelligence (AI) agent, the user AI agent comprising a large language model, wherein creating the instance of the user AI agent comprises tuning the user AI agent with one or more of a set of user objectives or a set of user constraints;
creating an instance of a system AI agent, the system AI agent comprising a large language model, wherein creating the instance of the system AI agent comprises tuning the system AI agent with one or more of a set of system objectives or a set of system constraints;
receiving, from a user client device associated with a user, a service request;
prompting the user AI agent to generate a message to an online system based on the received service request;
managing a plurality of rounds of messaging between the user AI agent and the system AI agent, wherein managing at least one round of the plurality of rounds of messaging between the user AI agent and the system AI agent comprises:
receiving, from the user AI agent, an output message,
prompting the system AI agent based on the output message from the user AI agent,
receiving, from the system AI agent, an output message, and
prompting the user AI agent based on the output message from the system AI agent;
extracting, from the messaging between the user AI agent and the system AI agent, a proposed agreement between the user and the online system responsive to the service request; and
outputting the proposed agreement to one or more of the user client device or the online system.
